(19) United States
(12) Patent Application Publication
(10) Pub. No.: US 2024/0279966 A1
(43) Pub. Date: Aug. 22, 2024

(54) VEHICLE DOOR HANDLE ASSEMBLY

(71) Applicant: MINEBEA ACCESSSOLUTIONS FRANCE, Alfortville (FR)

(72) Inventors: Christophe PERRIN, Alfortville (FR); Thomas DEVERNOIS, Alfortville (FR); Massimo FRATTINI, Alfortville (FR); Thomas LANNO, Alfortville (FR)

(73) Assignee: MINEBEA ACCESSSOLUTIONS FRANCE, Alfortville (FR)

(21) Appl. No.: 18/572,079

(22) PCT Filed: Jun. 16, 2022
(86) PCT No.: PCT/EP2022/066459

§ 371 Date: Dec. 19, 2023

(30) Foreign Application Priority Data
Jun. 24, 2021 (EP) 21315116.0

(51) Int. Cl. E05B 79/06; E05B 81/76

(52) U.S. Cl. CPC E05B 79/06; E05B 81/76

(57) ABSTRACT

A vehicle door handle assembly includes a bowl disposed in an opening of a door panel, the bowl having a recess inside of which is disposed an electric door latch switch. The bowl includes two complementary plastic parts which are each obtained in a separate molding process. The two complementary plastic parts are a lower-part bowl that is shaped like a bent pipe and designed to be fastened to the door panel, and a concave-shaped upper-part bowl that is configured to be assembled to the lower-part bowl so that the concave-shaped upper-part bowl forms a concave-shaped reception wall serving as an abutment for fingertips of a user when inserted inside the recess of the bowl.

### TECHNICAL FIELD

The present invention relates to the field of vehicle door handles to control the opening of vehicle doors and in particular to vehicle door handles comprising a bowl configured to be fastened to the door panel and electric door latches that are controlled via electric means to lock or release vehicle door panels in an automated fashion. Electric door latches, under normal circumstances, do not require bulging handle levers on the exterior surface of the vehicle. The air drag of the vehicle can consequently be reduced, while the visual aspect of the vehicle can be streamlined.

### BACKGROUND OF THE INVENTION

In the vehicle door handles of the state of the art, a bowl is disposed in an opening of a door panel and the bowl is fastened to the door panel, for example via a bracket and a slider positioned inside the door panel. The bowl provides a recess and an electric door latch switch may be disposed within the recess of the bowl. Thus, to actuated the electric door latch switch, the user puts his fingers within the recess to reach the electric door latch switch. The bowl is usually designed in such a way that it can be produced with a molding process.

In order to improve the aesthetics and the user's comfort when inserting their fingers inside the recess of the bowl, the shapes of the latter can be adapted in order to give the user a smoother feel and/or an improved hand position. One way to achieve this is to design the inner walls of the bowl in such a way that it mimics the bending of the user's fingers when reaching for the latch disposed within its recess. This implies that the bowl's recess is bent in such a way that its concave reception portion in which the latch is disposed is not directly facing the entrance area of the bowl's recess. In this case, the electric door latch switch is disposed in such a way that it is not visible from the outside.

However, such bowls can be rather difficult, sometimes even impossible to manufacture with a molding process, because the complexity of the shapes and more specifically the bent portion of the recess do not allow an easy way to unmold the final product. More specifically, it is almost impossible—or at least very difficult—to remove a part with steeply curved walls from an injection mold, as these prevent the installation of undercuts on the walls of the part. However, these undercuts are necessary to properly demold the part without deforming it, i.e. without risking the appearance of scratches and/or cracks that could potentially lead to the breakage of the plastic part.

### SUMMARY OF THE INVENTION

It is therefore a goal of the present invention to overcome at least partially the previous drawbacks of the state of the art and to provide a solution to avoid a breakage of the plastic part while still providing an improved shape for the bowl's recess.

Thus, the present invention refers to a vehicle door handle assembly comprising a bowl disposed in an opening of a door panel, the bowl having a recess inside of which is disposed an electric door latch switch, wherein the bowl comprises two complementary plastic parts which are each obtained in a separate moulding process, the two complementary plastic parts being on one hand a lower-part bowl that is shaped like a bent pipe and designed to be fastened to the door panel and on the other hand a concave-shaped upper-part bowl that is configured to be assembled to the lower-part bowl so that the upper-part bowl forms a concave-shaped reception wall serving as an abutment for a user's fingertips when inserted inside the recess of the bowl.

According to a further aspect of the invention the bent pipe forming the lower-part bowl is also funnel-shaped.

According to a further aspect of the invention, the bent pipe forming the lower-part bowl has an oblong-shaped cross-section.

According to a further aspect of the invention, the concave-shaped upper-part bowl comprises an oblong-shaped hole inside which a part of an electric door latch switch is disposed.

According to a further aspect of the invention, either the lower-part bowl or the upper-part bowl of the bowl comprises a plastic tongue that is configured to be inserted into an opening with a complementary shape placed on the other complementary part of the bowl.

According to a further aspect of the invention, the plastic tongue and the opening form together a clipping element that joins both parts of the bowl together.

According to a further aspect of the invention, the upper-part bowl comprises two plastic tongues that are placed near the outer edges and on either side of the longitudinal endings of said upper-part bowl.

According to a further aspect of the invention, the lower-part bowl comprises two openings that are respectively designed to cooperate with the plastic tongues of the upper-part bowl in order two form two distinct clipping elements that join both parts of the bowl together.

According to a further aspect of the invention, either the lower-part bowl or the upper-part bowl of the bowl comprises a longitudinal protrusion that is configured to be inserted into a rail that is placed on the other complementary part of the bowl.

According to a further aspect of the invention, the longitudinal protrusion and the rail form a slideway that joins both parts of the bowl together.

According to a further aspect of the invention, the longitudinal protrusion is located on one edge of the upper-part bowl and the rail is located on one edge of the lower-part bowl and these edges are configured to be brought into contact during assembly of the bowl.

According to a further aspect of the invention, the lower-part bowl and the upper-part bowl of the bowl are permanently assembled to each other using laser welding.

According to a further aspect of the invention, the lower-part bowl and the upper-part bowl of the bowl are permanently assembled to each other using ultrasound welding.

According to a further aspect of the invention, the lower-part bowl and the upper-part bowl of the bowl are permanently assembled to each other using glue.

### BRIEF DESCRIPTION OF THE DRAWINGS

FIG. 1a is a perspective view of an assembled bowl of a vehicle door handle assembly;

FIG. 1b is another perspective view of the assembled bowl from FIG. 1a that also shows an electric door latch switch disposed within the door handle assembly;

FIG. 2 is a perspective view of a lower-part bowl of the assembled bowl shown in FIG. 1a;

FIG. 3a is a first side view of the lower-part bowl of FIG. 2;

FIG. 3b is a second side view of the opposite end of the lower-part bowl of FIG. 2;

FIG. 4a is a perspective view of an upper-part bowl of the assembled bowl shown in FIG. 1a;

FIG. 4b is a similar view to FIG. 4a that also shows the electric door latch switch disposed within the door handle assembly;

FIG. 5a is a first side view of the upper-part bowl of FIG. 4;

FIG. 5b is a second side view of the opposite end of the upper-part bowl of FIG. 4;

FIG. 6a is a first side view of the assembled bowl shown in FIG. 1a;

FIG. 6b is a second side view of the opposite end of the assembled bowl shown in FIG. 1a;

FIG. 7a is a schematic view of a first step of an assembly process;

FIG. 7b is a schematic view of a second step in the same assembly process as the one in FIG. 7a;

FIG. 7c is a schematic view of a third and final step in the same assembly process shown in FIGS. 7a and 7b.

In these figures, identical elements have the same reference numbers. An XYZ trihedron is shown in all the figures to define the orientation of the bowl in space. A first direction, noted X, corresponds to a longitudinal direction of the handle. A second direction, denoted Y, is a normal to the plane that separates the upper-part bowl and the lower-part bowl. Finally, a third direction, denoted Z, is included in this same separation plane. The directions, X, Y, Z, are orthogonal to each other.

### DETAILED DESCRIPTION OF THE INVENTION

The following achievements are examples. Although the specification refers to one or several embodiments, it does not imply that each reference refers to the same embodiment or that the features apply only to a single embodiment. Simple features of different embodiments can also be combined to provide other embodiments.

In the following of the description, the terms up, upper, low, lower, vertical, horizontal refers to relative positions or directions when the door handle is assembled to a vehicle. In the description, certain items can be indexed, as the first item or second item. In this case, it is a simple indexing to differentiate and name similar but not identical elements. This indexing does not imply a priority of one element over another and such names can easily be interchanged without going beyond the scope of the present description. Nor does this indexing imply an order in time.

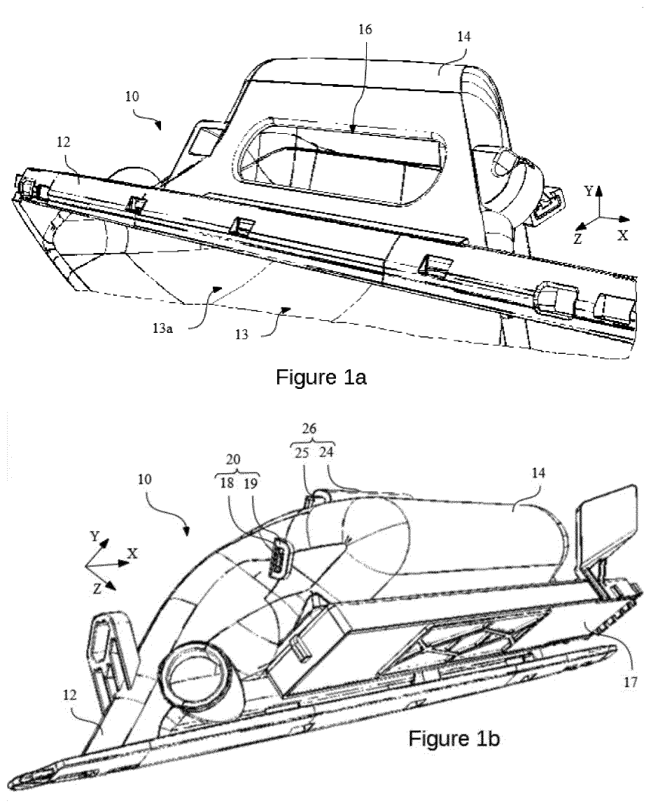

FIG. 1a and FIG. 1b are two schematic views of an embodiment of the bowl 10 of the vehicle door handle. This bowl 10 has a rather complex shape: the walls of the bowl are not only curved in a concave way, but also bent in an angle so that the inner reception wall of the recess inside the bowl 10 does not face the entrance area 13 in which the user is supposed to insert his fingers. This peculiar shape of the bowl 10 mimics the natural bending of human fingers when grasping a vehicle door handle in order to activate the electric door latch switch 17 shown in FIG. 1b. The bowl's inner walls are curved in such a way that the electric door latch switch 17 is invisible to a user when looking inside the entrance area 13 from the outside.

In order to take advantage of the improved shape of the bowl 10 without the need for a manufacturing method other than molding, the bowl 10 comprises two complementary plastic parts 12, 14 which are each obtained in a separate molding process and that are configured to be assembled together in a fitting manner.

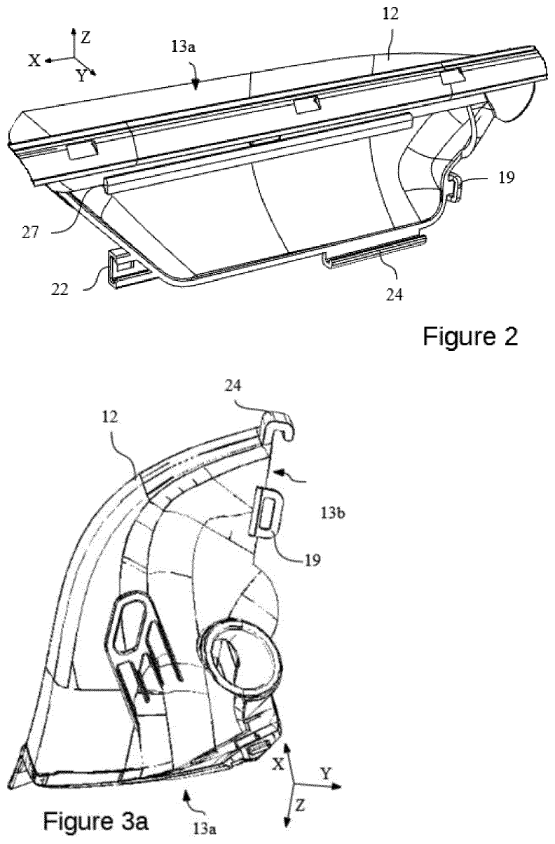

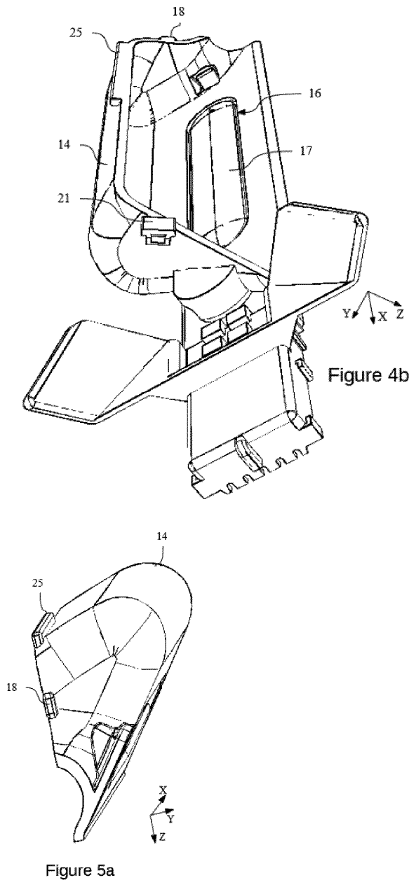

More specifically, the two complementary parts 12, 14 of the bowl 10 are on one hand a lower-part bowl 12 that is shaped like a bent pipe (see FIG. 2) and designed to be fastened to the door panel so that the entrance area 13 is accessible for the user and on the other hand a concave-shaped upper-part bowl 14 (see FIG. 4a) that is configured to be assembled to the lower-part bowl 12 so that the upper-part bowl 14 forms a concave reception wall for the recess inside the bowl 10, as depicted in FIGS. 1a and 1b.

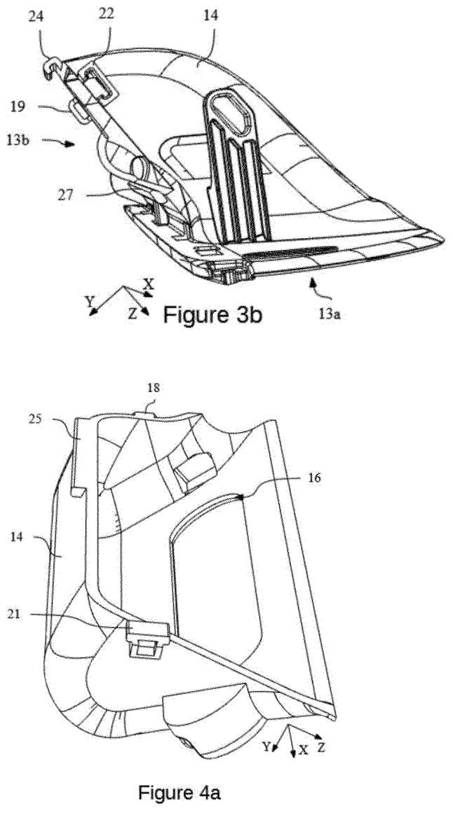

By «bent», it is meant that a lower end opening 13a forming the entrance area 13 and an upper end opening 13b at the ends of the plastic pipe forming the lower-part bowl 12 do not face each—other directly. The inclination angle between the planes comprising the edges of the lower end opening 13a and the upper end opening 13b at the ends of the pipe is for instance 120°, as shown in FIGS. 3a and 3b.

The bent pipe forming the lower-part bowl 12 can for instance be funnel-shaped as shown in FIG. 2. In this particular figure, the lower-part bowl 12 is flipped in order to emphasize the funneled shape of this part. The lower end opening 13a is hence represented above the upper end opening 13b in this particular drawing.

The edges of the upper end opening 13b that are destined to be covered by the upper-part bowl 14 mark the line of separation between both parts 12 and 14. This upper end opening 13b can be slightly smaller than the lower end opening 13a located on the enlarged side of the funnel-shaped bent pipe forming the lower-part bowl 12, as shown in FIG. 2.

The funnel-shaped bent pipe forming the lower-part bowl 12 can have an oblong-shaped cross-section. The width of the approximately oblong-shaped cross-section defines the depth of the lower-part bowl 12.

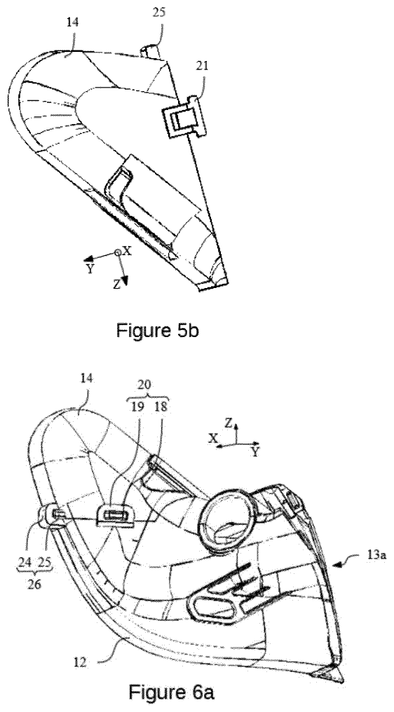

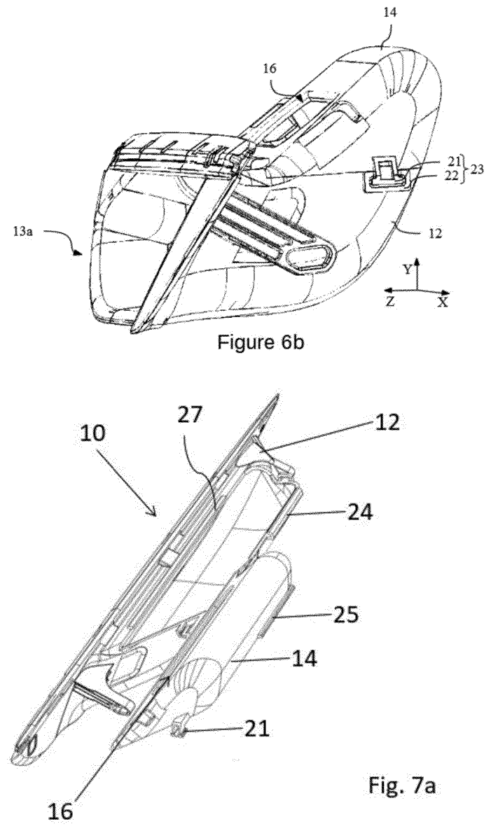

The concave-shaped upper-part bowl 14 is configured to be fitted on the edges of the upper end opening 13b of the funnel-shaped bent pipe forming the lower-part bowl 12. The bottom of the concave-shaped upper-part bowl 14 is rounded, as can be seen on the FIGS. 1a, 1b, 4a, 4b, 5a, 5b, 6a and 6b. When looked at from the side, as in FIGS. 5a and 5b or 6a and 6b, one can see that the upper-part bowl 14 may have a triangular-shaped or a fin-shaped cross section in the YZ plane.

The upper-part bowl 14 comprises an oblong-shaped hole 16 (see FIG. 4a) inside which a part of the electric door latch switch 17 is disposed, as depicted in FIG. 4b.

At least one of the two parts 12 or 14 of the bowl 10 comprises a plastic tongue 18, 21 that is configured to be inserted into an opening 19, 22 with a complementary shape placed on the other part 12 or 14 of the bowl 10. The plastic tongue 18, 21 and the corresponding opening 19, 22 form a clipping element 20, 23 that joins both parts 12 and 14 of the bowl 10 together.

According to the embodiment shown throughout the figures, the upper-part bowl 14 comprises two such plastic tongues 18 and 21 that are placed near the outer edges and on either side of the longitudinal endings of said upper-part bowl 14 (as shown in FIG. 4a). Consequently, the lower-part bowl 12 comprises two corresponding openings 19 and 22 that are located on the edge of the upper end opening 13b of the lower-part bowl 12 (see FIG. 2). These openings 19 and 22 are respectively designed to cooperate with their assigned plastic tongue 18 or 21 in order two form two distinct clipping elements 20 and 23 that join both parts 12 and 14 of the bowl 10 together when assembled to one another as depicted in FIG. 6a and in FIG. 6b.

The plastic tongues 18 and 21 can be elastically deformable, meaning that they can be slightly bent when inserted into the corresponding opening 19, 22 and returning to their original state after the elastic deformation. Once the plastic tongues 18, 21 are placed inside the corresponding opening 19, 22, the clipping element 20, 23 thus formed keep both parts 12, 14 of the assembly fitted together.

According to the embodiment shown in FIG. 5a, the first plastic tongue 18 is a cuboid protrusion located on one side-edge of the upper-part bowl 14. This cuboid protrusion fits into an opening 19 (see FIG. 3a) that has a complementary shape and that is located on one side-edge of the upper end opening 13b of the lower-part bowl 12.

According to the embodiment shown in the FIG. 5b, the second plastic tongue 21 is somewhat larger and bulkier than the first plastic tongue 18. The second plastic tongue 21 has a more complex shape: it can be hook-shaped and the cross section at the tip of this second plastic tongue 21 has the shape of an inverted «T» (see FIGS. 4a, 4b and 5b). Similarly, the second opening 22 in which the second plastic tongue 21 is configured to fit in has a different shape than the first opening 19. According to the embodiment shown in the FIG. 3b, the second opening 22 looks like a C-shaped claw.

The bowl 10 hence comprises two clipping elements 20 and 23 that are located on opposite side of the assembly formed by the lower-part bowl 12 and the upper-part bowl 14. Both clipping elements 20 and 23 are configured to hold the upper-part bowl 14 in place on top of the lower-part bowl 12. The sides of the concave-shaped upper-part bowl 14 are designed in such a way that they harmoniously follow the shape of the bowl's recess when the upper-part bowl 14 is fitted onto the lower-part bowl 12, as shown in FIGS. 6a and 6b.

Moreover, one of the two parts 12, 14 of the bowl 10 comprises a longitudinal protrusion 25 that is configured to be inserted into a rail 24 that is placed on the other part 12, 14 of the bowl 10, as shown in FIG. 1b. More specifically, the longitudinal protrusion 25 is located on one edge of the upper-part bowl 14 and the rail 24 is located on the edge of the upper end opening 13b of the lower-part bowl 12 destined to be brought into contact with the edge comprising the longitudinal protrusion 25 during assembly of the bowl 10.

The longitudinal protrusion 25 and the rail 24 form a slideway 26 that joins both parts 12 and 14 of the bowl 10 together. This implies that the rail 24 has a complementary shape to the longitudinal protrusion 25, so that when the longitudinal protrusion 25 is slid inside the rail 24, both parts 12, 14 of the bowl 10 are solidly fitted together. For instance, the rail 24 can have a hooked cross section as shown in FIGS. 3a and 3b. The inner side of this hook is configured so that it is wrapped around the three external sides of the longitudinal protrusion 25, as shown in FIG. 6a.

The longitudinal protrusion 25 can be slightly longer than the rail 24, meaning that part of the longitudinal protrusion 25 sticks out of the rail 24 when the upper-part bowl 14 is fitted onto the lower-part bowl 12, as depicted in FIG. 1b.

According to the embodiment of the lower-part bowl 12 shown in FIG. 2, this lower-part bowl 12 also comprises a longitudinal protrusion 27 located on the opposite edge than the one carrying the rail 24. This longitudinal protrusion 27 is longer than the one carried by the upper-part bowl 12. The side of the longitudinal protrusion 27 facing the opening 13b of the lower-part bowl 12 is destined to be brought into contact with a part of the edge of the upper-part bowl 14.

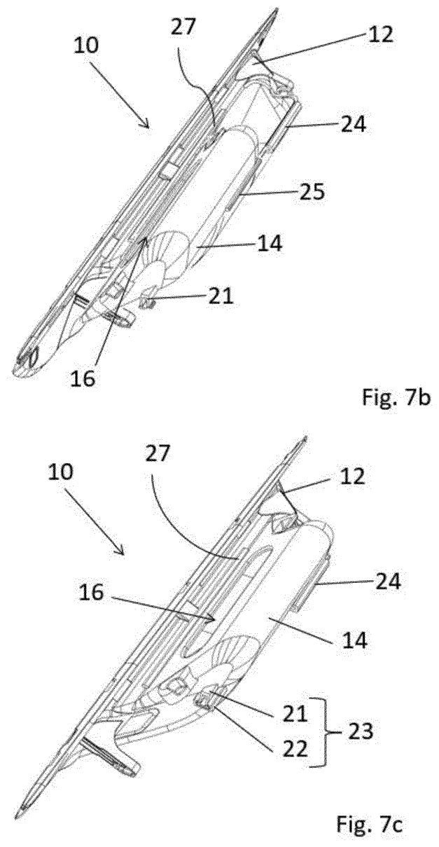

FIGS. 7a, 7b and 7c each show a step of an assembling process used to assemble the two parts 12 and 14 of the bowl 10 so that they fit together. In a first step pictured in FIG. 7a, the concave-shaped upper-part bowl 14 is placed next to the upper end opening 13b of the lower-part bowl 12. In a second step pictured in FIG. 7b, the edges of the concave-shaped upper-part bowl 14 are brought into contact with the lower-part bowl 12 so that the longitudinal protrusion 25 of the upper-part bowl 14 is aligned with the rail 24 located on the lower-part bowl 14. The upper-part bowl 14 is then slid sideways onto the lower-part bowl 12 so that the longitudinal protrusion 25 glides into the rail 24, as pictured in FIG. 7c. The slideway 26 formed by the longitudinal protrusion 25 and the rail 24 helps joining both parts 12 and 14 of the bowl 10 together by guiding the motion of the translation. The translation is complete when the first plastic tongue 18 has entered the first opening 19 on one longitudinal end of the assembly and when the T-shaped bulk forming the second plastic tongue 21 is securely fitted inside the C-shaped claw forming the second opening 22 on the opposite longitudinal end of the assembly, as shown in FIG. 7c which illustrates the third and last step of the assembling process.

The longitudinal protrusion 27 located on one edge of the lower-part bowl 12 may also help in guiding the translation, though this guidance may be a little less accurate than the one obtained with the slideway 26 formed by the longitudinal protrusion 25 and the rail 24 located on the other edge of the upper-part bowl 14.

Once the two complementary parts 12, 14 of the bowl 10 are fitted together, they can also be permanently assembled to each other. For instance, they can be welded to one another using laser welding on specific regions of the assembly. The laser welding can be applied on local regions of the assembly like the contact surface between the plastic tongues 18, 21 and the corresponding openings 19, 22 that form the clipping elements 20, 23 and/or along the contact surface between the rail 24 of the lower-part bowl 12 and the longitudinal protrusion 25 on the upper-part bowl 14 and/or the contact surface between the second longitudinal protrusion 27 on the lower-part bowl 12 and the edge on the side of the upper-part bowl 14.

The two complementary parts 12 and 14 of the bowl 10 can also be permanently assembled to each other using ultrasound welding. This type of welding is carried out using the heat generated by high frequency vibrations at the interface of the of the two parts 12 and 14.

Another way to assemble both complementary parts 12 and 14 of the bowl 10 permanently can be achieved by using a glue. Adding glue or using a welding process can increase the rigidity of the clipped assembly and ensures its robustness.

It is therefore possible to provide a vehicle door handle assembly comprising a bowl with an improved shape for the recess that is manufactured with a classic molding process.

1-11. (canceled)

12. A vehicle door handle assembly, comprising:
a bowl disposed in an opening of a door panel, the bowl having a recess inside of which is disposed an electric door latch switch, wherein
the bowl includes two complementary plastic parts which are each obtained in a separate molding process, and
the two complementary plastic parts are
a lower-part bowl that is shaped like a bent pipe and designed to be fastened to the door panel, and
a concave-shaped upper-part bowl that is configured to be assembled to the lower-part bowl so that the concave-shaped upper-part bowl forms a concave-shaped reception wall serving as an abutment for fingertips of a user when inserted inside the recess of the bowl.

13. The vehicle door handle assembly in accordance with claim 12, wherein the bent pipe forming the lower-part bowl is a funnel-shaped.

14. The vehicle door handle assembly in accordance with claim 12, wherein the bent pipe forming the lower-part bowl has an oblong-shaped cross-section.

15. The vehicle door handle assembly in accordance with claim 12, wherein the concave-shaped upper-part bowl comprises an oblong-shaped hole inside which a part of said electric door latch switch is disposed.

16. The vehicle door handle assembly in accordance with claim 12, wherein
one of the lower-part bowl and the concave-shaped upper-part bowl of the bowl includes a plastic tongue that is configured to be inserted into an opening with a complementary shape placed on another one of parts of the bowl, and
the plastic tongue and the opening form together a clipping element that joins both the lower-part bowl and the concave-shaped upper-part bowl of the bowl together.

17. The vehicle door handle assembly in accordance with claim 16, wherein
the concave-shaped upper-part bowl includes two plastic tongues that are placed near outer edges and on either side of longitudinal endings of said concave-shaped upper-part bowl, and
the lower-part bowl includes two corresponding openings that are respectively designed to cooperate with said plastic tongues in order to form two distinct clipping elements that join both the lower-part bowl and the concave-shaped upper-part bowl of the bowl together.

18. The vehicle door handle assembly in accordance with claim 12, wherein
one of the lower-part bowl and the concave-shaped upper-part bowl of the bowl includes a longitudinal protrusion that is configured to be inserted into a rail that is placed on another one of complementary parts of the bowl, and
the longitudinal protrusion and the rail form a slideway that joins both the lower-part bowl and the concave-shaped upper-part bowl of the bowl together.

19. The vehicle door handle assembly in accordance with claim 18, wherein the longitudinal protrusion is located on one edge of the concave-shaped upper-part bowl,
the rail is located on one edge of the lower-part bowl, and
the one edge of the concave-shaped upper-part bowl and the one edge of the lower-part bowl are configured to be brought into contact during an assembly of the bowl.

20. The vehicle door handle assembly in accordance with claim 12, wherein the lower-part bowl and the concave-shaped upper-part bowl of the bowl are permanently assembled to each other using laser welding.

21. The vehicle door handle assembly in accordance with claim 12, wherein the lower-part bowl and the concave-shaped upper-part bowl of the bowl are permanently assembled to each other using ultrasound welding.

22. The vehicle door handle assembly in accordance with claim 12, wherein the lower-part bowl and the concave-shaped upper-part bowl of the bowl are permanently assembled to each other using glue.
